(19) United States
(12) Patent Application Publication
(10) Pub. No.: US 2025/0047095 A1
(43) Pub. Date: Feb. 6, 2025

(54) METHOD FOR PROTECTING AGAINST FAULT ARCS

(71) Applicant: Siemens Aktiengesellschaft, München (DE)

(72) Inventors: Wolfgang Erven, Amberg (DE); Karsten Wenzlaff, Dresden (DE); Yi Zhu, Kümmersbruck (DE)

(21) Appl. No.: 18/847,792

(22) PCT Filed: Mar. 2, 2023
(86) PCT No.: PCT/EP2023/055294

§ 371 Date: Sep. 17, 2024

(30) Foreign Application Priority Data
Mar. 17, 2022 (DE) 10 2022 202 652.7

(51) Int. Cl. H02H 7/22; H02H 1/00

(52) U.S. Cl. CPC H02H 7/22; H02H 1/0015

(57) ABSTRACT

A method for protecting against arc faults in a hierarchically structured electrical distribution network includes distributing electrical energy from a feed-in point via a superordinate common main distribution line and from the common main distribution line via a plurality of subordinate outgoing feeder lines. The main distribution line can be interrupted by triggering a superordinate switch, and each of the outgoing feeder lines can be interrupted by triggering associated subordinate switches. After the arc fault is detected in the distribution network, the energy released by the fault arc is determined, and the triggering of the superordinate switch in order to extinguish the arc fault is blocked until the determined energy has exceeded a specified energy threshold. An arc fault protection unit, an electrical distribution network and a computer program product are also provided.

The present invention relates to a method for protecting against arc faults and to an arc fault protection unit.

Arcs can occur during operation, either in the form of a useful or working arc (e.g. as an ignition aid, in arc welding, in an arc furnace or in an arc lamp) or in the form of a switching arc that occurs during a switching operation between the contacts of a mechanical switch. If an arc does not occur during operation, but rather in an undesirable or unexpected manner as a result of a fault, this is referred to as an arc fault or arcing fault. Particularly in powerful distribution and switchgear installations, arc faults can lead to devastating destruction of equipment, installation parts or complete switchgear installations. In order to reduce damage and avoid a prolonged failure of the energy supply, it is necessary to detect and extinguish arc faults, in particular high-current or parallel arc faults, in a few milliseconds (≤5 ms) using an arc fault protection system.

An arc fault protection system can lead to a decision conflict regarding the priority of the protective mechanisms in a switchgear installation. An arc fault protection system has priority over all other protective mechanisms of the switchgear installation, as a result of its task of rapidly detecting an arc fault and immediately extinguishing it by interrupting the current in a superordinate area of the switchgear installation. A short-circuit algorithm of a circuit breaker that detects an arc fault in a subordinate area of the switchgear installation (outgoing feeder or outgoing branch circuit) associated with it as a short circuit is therefore overridden by the hierarchically superordinate arc fault protection system. The selectivity in the switchgear installation, namely the selective shutdown of the outgoing branch circuit (hereinafter also referred to as the outgoing feeder) in which there is a short circuit, without intervention in fault-free adjacent outgoing branch circuits, is thus overruled.

However, the absolute priority of the arc fault protection system, which is primarily designed for the high arc energies in a superordinate area of a switchgear installation, for example close to a point where the electrical energy is fed into the switchgear installation, is not always the best solution for another reason. In the case of many arc fault events, the arc is only very short-lived and goes out again automatically after a very short time since the energy released is very low and the conditions required for the arc's existence are not sustained. The damage caused by the arc fault can be relatively small in these cases, e.g. limited to a damage pattern with arc roots, relatively small molten spots and small traces of smoke, while the actual, far more expensive damage only arises when the entire switchgear installation is shut down.

There is therefore a need for an improved arc fault protection system.

This object is achieved by a method as claimed in claim 1. This object is also achieved by an arc fault protection unit as claimed in claim 7.

The method according to the invention serves to protect against arc faults in a hierarchically structured electrical distribution network in which electrical energy is distributed from a feed-in point via a superordinate common main distribution line and from the common main distribution line via a plurality of subordinate outgoing feeder lines. The electrical distribution network can be e.g. a switchgear installation or another circuit for distributing electrical energy. In this case, the main distribution line can be interrupted by triggering a superordinate switch, which is also referred to as main switch below. The superordinate switch (=main switch) can be designed as a feed-in switch or as a short-circuiting device or as a combination of feed-in switch and short-circuiting device. Arc faults that cannot be extinguished using a feed-in switch, i.e. a switch (mechanical switch or semiconductor switch), might arise; extinguishing the arc fault in this case May require a short-circuiting device which draws the arc fault current away from the main distribution line. Moreover, the outgoing feeder lines can each be interrupted by triggering a subordinate switch, also referred to as outgoing feeder switch below, assigned to the outgoing feeder line. The detection of the energy released by the arc fault follows the detection of an arc fault in the distribution network, with this detection being implemented on the basis of an evaluation of voltage and/or electrical current values in the main distribution line of the distribution network. Triggering the main switch for extinguishing the arc fault is blocked until the determined energy has reached a specified energy threshold value. Hereinafter, the arc fault is also referred to simply as “fault”.

The choice of energy threshold value defines a length of time before the main switch is triggered, during which an arc fault burning in one of the subordinate outgoing feeder lines can be extinguished by current value-dependent triggering of an outgoing feeder switch.

Thus one aspect of the invention consists in calculating energy values in addition to an i/u-algorithm and comparing said calculated energy values with a predefined energy threshold value. An algorithm which uses measured current and/or voltage values as inputs for detecting an arc fault is referred to as an i/u-algorithm; it is also referred to as i/u-detection-algorithm. A decision regarding the activation of a main switch, which preferably comprises a short-circuiting device and/or a feed-in switch, in order to resolve a detected arc fault, i.e. extinguish a detected arc fault, is made when a) the “energy threshold value exceeded” criterion and b) defined i/u-criteria are satisfied simultaneously. The energy threshold value is defined according to the system configuration and protection requirements. In this case, the energy can be calculated by way of I*U*t or an integral over i*u*dt.

Thus the invention does not only consist in delaying the triggering of the main switch until the energy released by the arc fault has reached the specified energy threshold value. Instead, the arc fault protection system initially provides the outgoing feeder switches with the possibility of extinguishing the arc fault if the arc fault is located downstream of the outgoing feeder switches. Only if none of the outgoing feeder switches react before the energy threshold value is reached is the block on triggering the main switch lifted to allow the main switch to trigger if its trigger conditions are met. Hence, the invention allows distinguishing between a fault in one of the outgoing feeder lines and a fault in the main distribution line. A fault in one of the outgoing feeder lines is resolved by the outgoing feeder switch. Thus the fault current is limited and the energy threshold value is not reached; accordingly, the main switch is not triggered either. If there still is a fault current above the first trigger threshold of the main switch in the distribution network after the predefined energy threshold value has been reached, then this means that the arc fault is in the main distribution line; consequently, the arc fault protection system reacts immediately by triggering the main switch.

The arc fault protection unit according to the invention is designed for a hierarchically structured electrical distribution network, which comprises at least one superordinate switch and subordinate switches. The arc fault protection unit comprises an interface for receiving voltage and/or electrical current values of the distribution network and for sending signals to the superordinate switch. The arc fault protection unit comprises a data memory for storing a specified energy threshold value. The arc fault protection unit comprises a processor that is configured to detect an arc fault in the distribution network on the basis of voltage and/or electrical current values of the distribution network, to determine the energy released by the arc fault on the basis of current values and voltage values measured in the distribution network and compare said released energy with the energy threshold value, and to block triggering of the superordinate switch for extinguishing the arc fault until the determined energy has exceeded the energy threshold value.

In this case, an arc fault protection system is formed by the arc fault protection unit, by a detection device, e.g. a current and/or voltage sensor, configured to capture voltage and/or electrical current values of the distribution network and send said values to the arc fault protection unit, and by an arc fault protection switch configured to interrupt its current in the distribution network either following the reception of a trip signal from the arc fault protection unit for extinguishing the arc fault or if a current value in the distribution network exceeds a threshold value and there is no blocking command in relation to the energy threshold value on part of the arc fault protection unit.

Thus, depending on which energy released by the arc fault in the distribution network is tolerable in the different distribution levels of the distribution network, the trip signal from the arc fault protection unit to an arc fault protection switch in a superordinate level of the distribution network (also referred to as protection area I) can be delayed and during this time protective switching equipment in a subordinate level of the distribution network (also referred to as protection area II) can be given time to resolve the fault, i.e. the arc fault, before the trip signal from the arc fault protection unit to the arc fault protection switch causes the entire distribution network to be shut down. The selectivity in the distribution network can thus be guaranteed up to a defined level of damage, corresponding to the tolerated energy release of the arc fault.

The term “level” of the distribution network should not be construed as limiting the structure of the distribution network; it should simply be regarded as an area, in particular a protection area, of the distribution network. The term “level” considers the distribution network from a more hierarchical perspective, while the term “area” with regards to the distribution network rather emphasizes its grid-like structure. It is essential that electrical energy, which is intended to reach a subordinate level or a subordinate area of the distribution network from the feed-in point, must pass through the superordinate level or the superordinate area. Thus, an interruption of the current in the main line in the superordinate level or in the superordinate area causes no more current to flow in the subordinate levels or in the subordinate areas of the distribution network either.

In the arc fault protection system, a waiting time corresponding to the arc energy is derived, depending on the expected level of damage. This means that the actual triggering and resolution of the fault in a superordinate level of the distribution network is no longer undelayed, but rather dependent on the arc energy (=damage energy).

In particular, four different scenarios a to d of an arc fault can be considered:
a) In the case of an arc fault which releases relatively small amounts of energy insufficient to sustain the arc fault as insufficient amounts of conductive plasma are created, the arc fault extinguishes itself without causing significant damage to the distribution network. The arc fault protection system is not activated in this case.
b) In the case of an arc fault in protection area I, the fault current will usually be in the short circuit range. The higher the arc fault current, the shorter the time interval until the energy threshold value is exceeded. Should the energy threshold value be exceeded in the context of the i/u-detection-algorithm, the arc fault protection system actively extinguishes the arc fault.
c) In the case of an arc fault in protection area II, the arc fault is extinguished by the relevant outgoing feeder switch, which is very fast in many cases. The energy threshold value is not exceeded in this case.
d) In the case of an arc fault in protection area II, the arc fault protection system is activated after the energy threshold value has been reached in the case in which such a large outgoing feeder switch is installed upstream of the protection area that it is too slow to shut down the arc fault. In this case, the arc fault protection system serves as backup protection for the outgoing feeder switches.

Advantageous configurations and developments of the invention are specified in the dependent claims. In this case, the method according to the invention can also be developed according to the dependent device claims and vice versa.

According to a preferred configuration, the energy of the arc fault is calculated via the product U·I·Δt or the integral E_{LB}=∫U(t)·I(t) dt over time, where U=voltage across the arc fault, I=electrical current through the arc fault, and Δt=burning time of the arc fault. In this context, attention is drawn to the fact that uppercase letters U, I and lowercase letters u, i are not intended to have different meanings: both can label both direct current and alternating current. The arc energy E_{LB} is calculated by way of E_{LB}=U·I·Δt, where U=voltage across the arc, I=current through the arc, and Δt=burning time of the arc. The formula specified above is only an estimate as voltage and current values of an arc fault are generally time varying; an exact value of the arc energy released is given by the time integral E_{LB}=∫U(t)·I(t) dt, where the integration is carried out over the burning time of the arc fault. The energy threshold value and hence the delay time of the main switch derived therefrom should be chosen according to the tolerable level of damage.

According to a preferred configuration, the energy released by the arc fault is only determined starting from a time at which the current intensity in the main distribution line has exceeded a specified first trigger threshold of the superordinate switch, the exceeding of which is a criterion for identifying an arc fault in the distribution network.

When calculating the arc energy by way of E_{LB}=U·I·Δt, the burning time of the arc thus only starts once the current intensity in the main distribution line has exceeded a specified first trigger threshold of the superordinate switch. When calculating the arc energy by way of E_{LB}=∫U(t)·I(t) dt, the lower temporal integration bound is the time at which the current intensity in the main distribution line has exceeded a specified first trigger threshold of the superordinate switch.

An arc fault in the distribution network is detected on the basis of i/u-criteria. One of the i/u-criteria is whether the current intensity in the main distribution line has exceeded a specified first trigger threshold. The arc fault protection system assumes that an arc fault is burning in the distribution network as soon as all i/u-criteria have been satisfied. Only at that point is a distinction made on the basis of an energy threshold value as to whether the fault is located in a superordinate level of the distribution network that can be shut down by the main switch (also referred to as protection area I) or in a subordinate level of the distribution network that can be shut down by the outgoing feeder switches (also referred to as protection area II). The energy calculation should only be started once a current threshold of the main switch has been exceeded. The reason is as follows: The arc fault is resolved by an outgoing feeder switch in the case of an arc fault in protection area II downstream of an outgoing feeder switch. Hence the energy released by the arc fault does not reach the energy threshold value. By contrast, in the case of an arc fault in protection area I, the arc fault will burn until the energy threshold value has been reached and the main switch, which preferably comprises a short-circuiting device and a feed-in switch, is subsequently activated. Thus, the invention brings about a delay before the main switch is activated.

Since the energy is calculated by way of U·I·Δt, the energy is also only calculated in the case of a current above the specified first trigger threshold. Hence the i-criterion is always satisfied when the energy threshold value is reached. Should the energy threshold value be reached but the u-criterion not be satisfied, e.g. it is not arc faults but other types of arcs that are burning in protection area II, this usually indicates that the outgoing feeder switch is no longer able to shut down the fault; in this case, the main switch must be activated as backup protection.

According to a preferred configuration, the superordinate switch is triggered only once the determined energy has exceeded a specified energy threshold value and a current value in the distribution network is above a specified first current threshold value, the current value in the main distribution line preferably being above a specified first trigger threshold of the superordinate switch.

According to a preferred configuration, the arc fault is detected on the basis of voltage and/or electrical current values of the distribution network. By preference, the arc fault is detected by means of an algorithm for detecting arc faults, which evaluates the voltage and current values of the distribution network.

According to a preferred configuration, a subordinate switch is triggered as soon as the current value in the associated outgoing feeder line is above a specified second trigger threshold of the subordinate switch. The outgoing feeder lines can each be interrupted by an associated outgoing feeder switch, wherein, in the case of a defined excess current or short circuit current, an outgoing feeder switch interrupts the outgoing feeder line associated therewith.

According to the invention, the distribution network is not interrupted by a superordinate arc fault protection switch for extinguishing the arc fault before the energy of the arc fault has exceeded a specified energy threshold value.

According to a preferred configuration, the tripping algorithm implemented on a processor of the arc fault protection unit is supplemented with at least one energy threshold value for the converted arc energy. Supplementing the tripping algorithm with an energy-dependent threshold value or a waiting time dependent thereon makes it possible to avoid unplanned spontaneous shutdown of the distribution network, which would leave intolerable damage behind. The distribution network can continue to be operated and an unplanned installation downtime can be avoided. The fault can be searched for at a later scheduled time. A further advantage is the scalability of the threshold value which can be adapted to respective conditions and design variables of the distribution network, e.g. feed-in power, and topologies, e.g. size of the outgoing feeders, cooling effect of busbars.

Another advantage is that arc faults, e.g. short circuits, in subordinate distribution levels, which are protected by the protective switching equipment provided for this purpose in the outgoing feeders, are not overridden by the arc fault circuit breaker and there is no shutdown of the entire distribution network.

According to a preferred configuration of the arc fault protection unit, the one processor is configured to compare current values measured in the distribution network with a specified current threshold value stored in the data memory, and to send a trip signal to the superordinate switch once the determined energy has exceeded a specified energy threshold value and a measured current value in the distribution network is above a specified first trigger threshold of the superordinate switch.

A further aspect of the invention relates to an electrical distribution network which comprises a sensor that is configured to capture voltage and/or electrical current values of the distribution network, and which comprises an arc fault protection unit according to one of the descriptions above.

A further aspect of the invention relates to a computer program product comprising commands which cause the arc fault protection unit according to one of the descriptions above to perform the method steps of the method according to one of the descriptions above.

A further preferred configuration of the invention is a computer program product which can be loaded directly into the internal memory of a digital computing unit and comprises software code sections with which the method, as described above, is carried out.

The computer program product is designed to be executable in a processor. The computer program product may be stored as software or firmware in a memory and may be designed to be able to be executed by a computer. As an alternative to that or in addition, the computer program product may also be designed at least partially as a hard-wired circuit, for example as an ASIC. The computer program product is designed to receive measured values acquired by sensors, to evaluate them and to generate control commands to switches or protective switching equipment of the energy distribution installation. According to the invention, the computer program product is designed to implement and carry out at least one embodiment of the outlined method for extinguishing an arc fault. In this case, the computer program product may combine all the partial functions of the method, that is to say may be of monolithic design. As an alternative, the computer program product may also be configured in a segmented manner and may in each case distribute partial functions to segments that are executed on separate hardware. For example, part of the method can be carried out in a control unit, and another part of the method can be carried out in a higher-order control unit, such as a PLC or a computer cloud.

Also proposed is a computer program product which can be loaded directly into the internal memory of a digital computing unit and comprises software code sections with which the steps of the method described herein are carried out when the product runs on the computing unit. The computer program product can be stored on a data carrier, such as a USB memory stick, a DVD or a CD-ROM, a flash memory, EEPROM or an SD card. The computer program product can also be present in the form of a signal that can be loaded via a wired or wireless network.

The method is realized for automatic execution, preferably in the form of a computer program. The invention is therefore on the one hand also a computer program having program code instructions that can be executed by a computer and on the other hand a storage medium having a computer program of this type, that is to say a computer program product having program code means and finally also an energy source or a tertiary control unit, in the memory of which such a computer program is or can be loaded as means for carrying out the method and its embodiments.

Instead of a computer program having individual program code instructions, the implementation of the method described here and in the following can also take place in the form of firmware. It is clear to a person skilled in the art that instead of an implementation of a method in software, an implementation in firmware or in firm—and software or in firm—and hardware is also always possible.

Therefore, it should be true for the description presented here that the term software or the term computer program also includes other implementation possibilities, namely particularly an implementation in firmware or in firm—and software or in firm—and hardware.

The above-described characteristics, features and advantages of this invention and the manner in which these are achieved will become clearer and considerably more comprehensible through the following description, which is explained in more detail with reference to the drawing. In the drawing, in each case schematically and not true to scale,

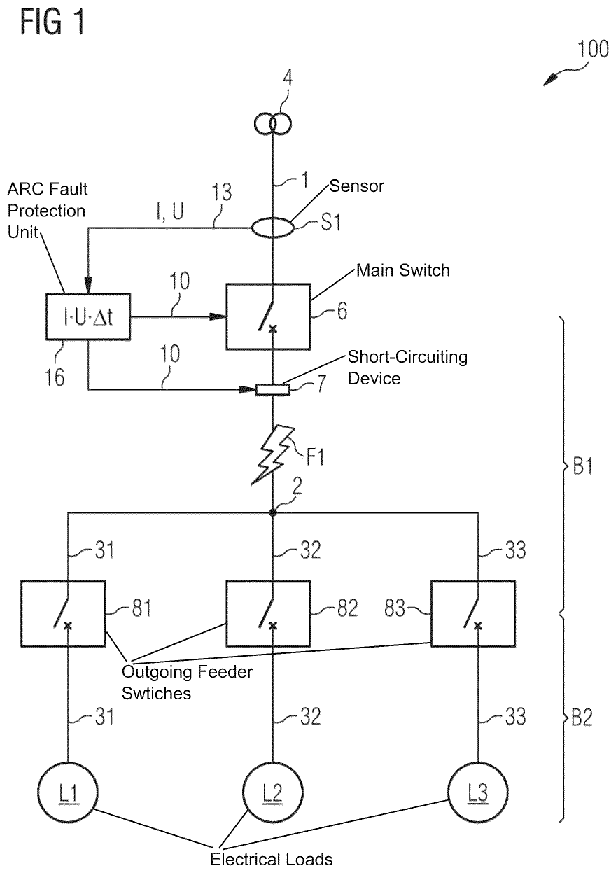

FIG. 1 shows an electrical energy distribution installation with an arc fault in a superordinate level;

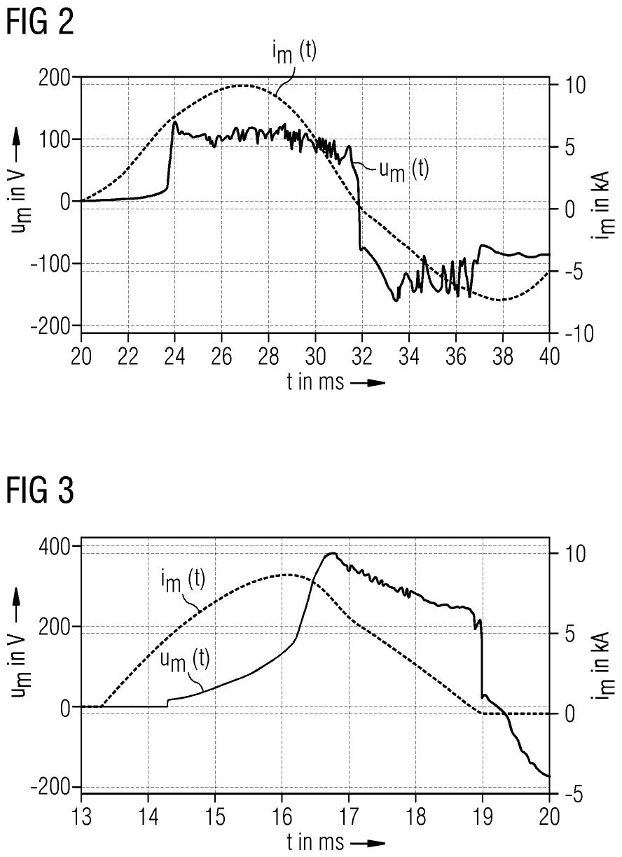

FIG. 2 shows a first graph of the variation in voltage and current over time during arc fault ignition,

FIG. 3 shows a first graph of the variation in voltage and current over time during switching arc ignition,

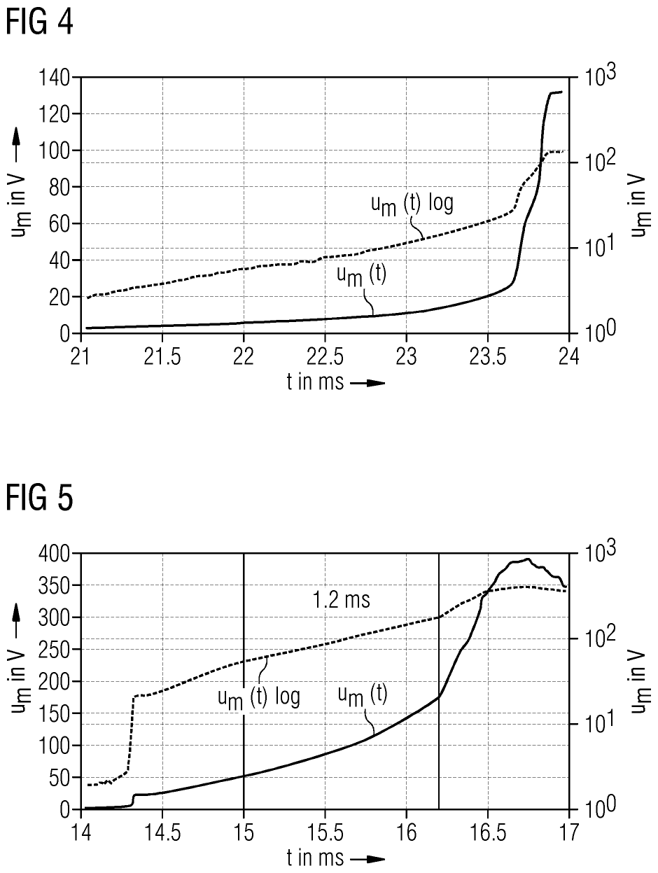

FIG. 4 shows a semi-logarithmic graph of the variation in voltage over time during arc fault ignition,

FIG. 5 shows a semi-logarithmic graph of the variation in voltage over time during switching arc ignition,

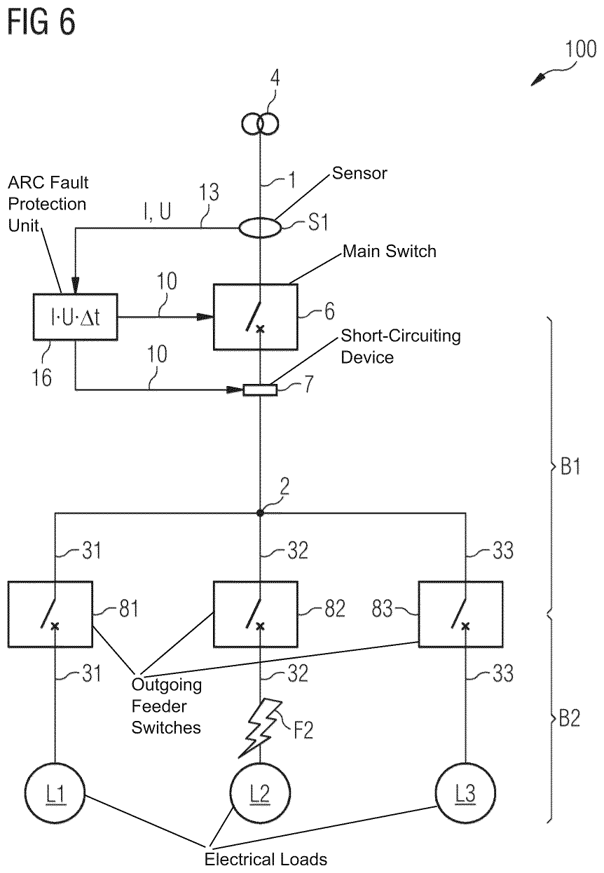

FIG. 6 shows the electrical energy distribution installation depicted in FIG. 1, with an arc fault in a subordinate level;

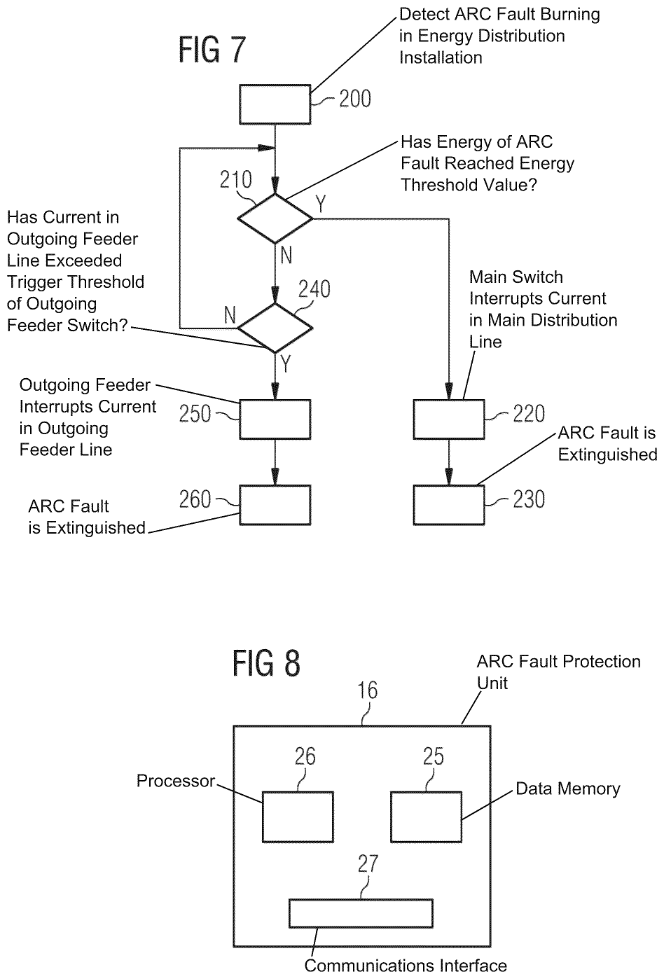

FIG. 7 shows a flowchart of an algorithm for performing a method according to the invention;

FIG. 8 shows an arc fault protection unit; and

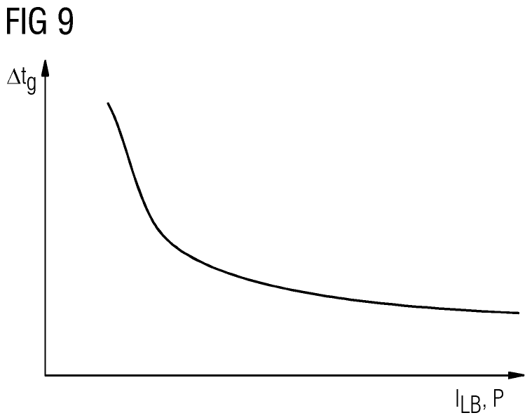

FIG. 9 shows an I/t or P/t graph in relation to the energy threshold value.

FIG. 1 shows an electrical distribution network in the form of an electrical energy distribution installation 100 in which electrical energy is conducted from a feed-in point 4 via a superordinate common main distribution line 1. The common main distribution line 1 branches at a branching point 2 into three subordinate outgoing feeder lines 31, 32, 33 which each conduct the electrical energy provided at the feed-in point 4 to an electrical load L1, L2, L3, for example electric motors. In this case, the main distribution line 1 forms a superordinate level B1 of the electrical energy distribution installation 100, the so-called main level, and the outgoing feeder lines 31, 32, 33 form a subordinate level B2 of the electrical energy distribution installation 100, the so-called lower distribution level or outgoing feeder level. By way of example, if the assumption is made that each of the electrical loads L1, L2, L3 has the same power, then the current flowing through the main distribution line 1 divides at the branching point 2 into three currents of approximately equal intensity in the outgoing feeder lines 31, 32, 33 according to Kirchhoff's First Law (junction rule), i.e. the current intensity of a current in one of the outgoing feeder lines 31, 32, 33 is approximately one third of the current intensity of the current flowing through the main distribution line 1.

The common main distribution line 1 and the outgoing feeder lines 31, 32, 33 may be designed for a single-phase or a multi-phase power line from the feed-in point 4 to the electrical loads L1, L2, L3. For a single-phase power line, it is sufficient if the lines 1, 31, 32, 33 each have a single current conductor, and optionally a current return conductor or a neutral conductor. For a three-phase power line, i.e. in a three-phase grid for three-phase alternating current, it is sufficient if the lines 1, 31, 32, 33 each have three separate current conductors-one conductor each for one of the three current phases; in addition, a neutral conductor may be present.

A main switch 6 and a short-circuiting device 7 are connected in series in the main distribution line 1. The main distribution line 1 can be interrupted by the main switch 6, which is designed as a circuit breaker, e.g. an ACB (=Air Circuit Breaker), and short-circuited by the short-circuiting device 7; in both cases, an arc that burns in the superordinate level B1 or in the subordinate level B2 is extinguished. In alternative embodiments, only a main switch 6 or only a short-circuiting device 7 is connected into the main distribution line 1.

The outgoing feeder lines 31, 32, 33 can each be interrupted by an associated piece of protective switching equipment 81, 82, 83—hereinbelow also referred to as outgoing feeder switch. The protective switching equipment 81, 82, 83 can be designed as a circuit breaker, e.g. an ACB, an MCCB (=molded case circuit breaker), an MCB (=miniature circuit breaker) or a fuse.

In the main distribution line 1, a sensor S1 for determining measured values of voltage U and current I is arranged in the main distribution line 1. The sensor S1 is connected to a sensor line 13 for transmitting the measured values captured by the sensor S1 to an arc fault protection unit 16 which is also referred to as PADD (=Parallel Arc Detection Device). From the arc fault protection unit 16, control lines 10 run to the main switch 6 and the short-circuiting device 7 for transmitting control signals, e.g. a trip signal or a blockage signal, from the arc fault protection unit 16 to the main switch 6 and the short-circuiting device 7.

The arc fault protection unit 16 is configured to detect the burning of an arc fault F1 in the energy distribution installation 100 on the basis of voltage and electrical current values measured by the sensor S1 in the main distribution line 1.

A current and voltage curve which has a significant variation can be measured in the circuit or network in which an arc is burning. A typical voltage curve uₘ (t) over time and a current curve iₙ (t) over time for an arc fault are shown in FIG. 2. This shows an illustration of a graph in which the variation of the voltage U and of the electrical current I over time following the ignition of an arc or arc fault, in particular parallel arc faults, in an electrical circuit, in particular a low-voltage circuit, is illustrated.

The time t in milliseconds (ms) [t in ms] is plotted on the horizontal x-axis. The magnitude of the voltage uₘ in volts (V) [uₘ in V] is plotted on the vertical y-axis on the left-hand scale. The magnitude of the electrical current iₘ in kiloamperes (kA) [iₘ in kA] is plotted on the right-hand scale.

Following arc ignition, the current I runs on approximately sinusoidally. The voltage U runs in a highly distorted manner, approximately in a zig-zag shape with rapid voltage changes. In a rough interpretation, the voltage curve is rectangular to a first approximation, instead of a conventionally sinusoidal curve. When considered in abstraction, a square-wave form that exhibits a highly stochastic component on the plateau can be seen in the voltage curve. The square-wave form is characterized in that, during arc ignition and at the subsequent voltage zero crossings of the AC voltage, significantly increased voltage changes occur, which are subsequently referred to as a voltage jump, since the increase in the voltage change is much greater in comparison with a sinusoidal voltage profile.

FIG. 3 shows a graph of the voltage and current curve over time according to FIG. 2, with the difference of switching arc ignition.

If the curves according to FIGS. 2 and 3 are represented semi-logarithmically, then, according to FIGS. 4 and 5, the behavior in the voltage curve that is typical for a switching arc and deviates from an arc fault is exhibited.

FIG. 4 shows an illustration of the voltage curve uₘ (t), uₘ (t) log over time during arc fault ignition according to FIG. 2, firstly in a linear uₘ (t) and secondly in a semi-logarithmic uₘ (t) log depiction. The time t in milliseconds (ms) [t in ms] is plotted on the horizontal x-axis. The magnitude of the voltage uₘ in volts (V) [uₘ in V] is plotted in a linear representation on the vertical y-axis on the left-hand scale. The magnitude of the voltage uₘ in volts (V) [uₘ in V] is plotted in a logarithmic representation on the right-hand scale.

FIG. 5 shows a graph according to FIG. 4, with the difference of switching arc ignition.

In a circuit or network, it is therefore possible to detect the burning of an arc fault on the basis of the current and voltage values. Such a method is described, for example, in DE102016209445A1 (Siemens AG; TU Dresden) 30 Nov. 2017.

The arc fault protection unit 16 depicted in FIG. 1 is moreover configured to calculate the energy of an arc fault in the energy distribution installation 100 on the basis of voltage and electrical current values measured by the sensor S1 in the main distribution line 1. In this case, the arc energy E_{LB} is calculated by way of the formula E_{LB}=U·I·Δt, where U=voltage across the arc=voltage between the two conductors between which the arc burns; I=current through the arc=current through the two conductors between which the arc burns; Δt=burning time of the arc.

The arc fault protection unit 16 compares the arc energy E_{LB}, which increases continually with the burning time, with a specified threshold value. Should the arc energy E_{LB} be less than the threshold value, the potential damage to the energy distribution installation 100 caused by the arc fault still is tolerable; in this case, the arc fault protection unit 16 still waits for the arc fault to be extinguished by an outgoing feeder switch 81, 82, 83. However, should the arc energy E_{LB} reach the threshold value, the potential damage to the energy distribution installation 100 caused by the arc fault is no longer tolerable; in this case, the arc fault protection unit 16 sends a trip signal to the main switch 6, in order to extinguish the arc fault.

Two different situations are shown in FIGS. 1 and 6. In a first scenario shown in FIG. 1, an arc fault F1 is burning in the superordinate level B1 of the energy distribution installation 100, namely in the main distribution line 1 between the main switch 1 and the branching point at which the main distribution line 1 branches into the outgoing feeder lines 31, 32, 33. In a second scenario shown in FIG. 6, an arc fault F2 is burning in the subordinate level B2 of the energy distribution installation 100, namely in the central outgoing feeder line 32 between the branching point, at which the main distribution line 1 branches into the outgoing feeder lines 31, 32, 33, and the second load L2 supplied with electrical energy by the central outgoing feeder line 32.

In both situations, the sensor S1 of the main distribution line 1 measures the measured values of current I and voltage U, which are characteristic of an arc fault and are transmitted via the sensor line 13 to the arc fault protection unit 16. From this, the arc fault protection unit 16 calculates the arc energy E_{LB} and compares the latter with a specified energy threshold value E_{S}, which is stored in the arc fault protection unit 16. As soon as the arc energy E_{LB} reaches the energy threshold E_{S}, the arc fault protection unit 16 sends a trip signal to the main switch 6 via the control line 10.

FIG. 7 shows a possible method sequence which, for example, can be implemented in the form of an algorithm. In a first step 200, an arc fault burning in the energy distribution installation 100 is detected on the basis of current and/or voltage values of the main distribution line 1. This time to of detection is stored as the ignition time of the arc fault. In a subsequent step 210, a check is performed on the basis of the read-in current and voltage values of the main distribution line 1 at a time t> to as to whether the energy E_{LB} of the arc fault released since the ignition time, calculated using the formula E_{LB}=U·I·Δt with Δt=t−t0, has reached the specified energy threshold value E_{S}.

If yes (Y), the main switch is prompted in step 220 by way of a trip signal from the arc fault protection unit 16 to interrupt the current in the main distribution line 1. As a consequence of interrupting the main distribution line 1 acting as feed-in line of the energy distribution installation 100, the energy distribution installation 100 is deenergized, and the arc fault is extinguished in step 230 regardless of its location in the energy distribution installation 100.

If no (N), a check is performed in the outgoing feeder switches within step 240 as to whether the current in the respectively associated outgoing feeder line exceeds the respective trigger threshold of the outgoing feeder switch, e.g. on account of an excess current or short circuit current. If yes (Y), the outgoing feeder switch whose trigger threshold was exceeded interrupts the current in the associated outgoing feeder line in step 250. As a consequence of interrupting the outgoing feeder line acting as outgoing branch of the energy distribution installation 100, an outgoing branch of the energy distribution installation 100 is de-energized, and the arc fault burning in this outgoing branch of the energy distribution installation 100 is extinguished in step 260. If no (N), a jump is made to step 210 again.

FIG. 8 shows an arc fault protection unit 16 which comprises a processor 26, a data memory 25 and a communications interface 27. Via the communications interface 27, the arc fault protection unit 16 is able to receive data, for example current and voltage measured values from sensors such as e.g. the sensor S1 arranged on the main distribution line 1, or computer program data from higher-order entities, such as a control center or a controller, and transmit data, for example control signals to switches such as e.g. the main switch 6 arranged in the main distribution line 1. Data, e.g. current and voltage measured values from sensors or computer programs, can be stored in the data memory 25. The processor 26 can execute computing steps, for example load a computer program deposited in the data memory 25 into a working memory of the processor 26 and process it as a computational algorithm.

FIG. 9 shows an I/t or P/t graph in relation to the energy threshold value. In this case, the length Δt_{S} of time until the energy threshold E_{S} is reached is plotted against the arc fault current I_{LB} and the feed-in power P at the feed-in point of the distribution network. The higher the arc fault current or feed-in power, the shorter the time interval Δt_{S} until the energy threshold value is exceeded. Thus, the temporal requirements in respect of the arc fault system increase with the feed-in power.

1-10. (canceled)

11. A method for protecting against arc faults in a hierarchically structured electrical distribution network, the method comprising:
distributing electrical energy from a feed-in point over a superordinate common main distribution line and from the common main distribution line (1) over a plurality of subordinate outgoing feeder lines;
triggering a superordinate switch for interrupting the main distribution line, and triggering associated subordinate switches for interrupting each of the outgoing feeder lines;
detecting an arc fault in the distribution network followed by determining energy released by the arc fault, and blocking triggering of the superordinate switch for extinguishing the arc fault until the determined energy has exceeded a specified energy threshold value.

12. The method according to claim 11, which further comprises determining the energy of the arc fault by a product U·I·Δt or an integral E_{LB}=∫U(t)·I(t) dt over time, where U=voltage across the arc fault, I=electrical current through the arc fault, and Δt=burning time of the arc fault.

13. The method according to claim 11, which further comprises determining the energy released by the arc fault only starting from a time at which a current intensity in the main distribution line has exceeded a specified first trigger threshold of the superordinate switch, and the exceeding of the specified first trigger threshold is a criterion for identifying an arc fault in the distribution network.

14. The method according to claim 11, which further comprises triggering the superordinate switch once the determined energy has exceeded a specified energy threshold value and a current value in the distribution network is above a specified first trigger threshold of the superordinate switch.

15. The method according to claim 11, which further comprises detecting the arc fault based on at least one of voltage or electrical current values of the distribution network.

16. The method according to claim 11, which further comprises triggering a subordinate switch as soon as a current value in the associated outgoing feeder line is above a specified second trigger threshold of the subordinate switch.

17. An arc fault protection unit for a hierarchically structured electrical distribution network, the arc fault protection unit comprising:
at least one superordinate switch and subordinate switches;
an interface for receiving at least one of voltage or electrical current values of the distribution network and for sending signals to said at least one superordinate switch;
a data memory for storing a specified energy threshold value; and
a processor configured:
to detect an arc fault in the distribution network based on the at least one of voltage or electrical current values of the distribution network;
to determine energy released by the arc fault based on current values and voltage values measured in the distribution network and to compare the released energy with the specified energy threshold value; and
to block triggering of the superordinate switch for extinguishing the arc fault until the determined energy has exceeded the energy threshold value.

18. The arc fault protection unit according to claim 17, wherein said processor is configured:
to compare current values measured in the distribution network with a specified current threshold value stored in said data memory; and
to send a trip signal to said superordinate switch once the determined energy has exceeded a specified energy threshold value and a measured current value in the distribution network is above a specified first trigger threshold of the superordinate switch.

19. An electrical distribution network, comprising:
a sensor configured to capture at least one of voltage or electrical current values of the distribution network; and
an arc fault protection unit according to claim 17.

20. A non-transitory computer program product, comprising commands causing the arc fault protection unit according to claim 17 to perform a method for protecting against arc faults in a hierarchically structured electrical distribution network, the method including:
distributing electrical energy from a feed-in point over a superordinate common main distribution line and from the common main distribution line over a plurality of subordinate outgoing feeder lines;
triggering the at least one superordinate switch for interrupting the main distribution line, and triggering the associated subordinate switches for interrupting each of the outgoing feeder lines; and
detecting an arc fault in the distribution network followed by determining the energy released by the arc fault, and blocking triggering of the superordinate switch for extinguishing the arc fault until the determined energy has exceeded a specified energy threshold value.
